(19) United States
(12) Patent Application Publication
(10) Pub. No.: US 2022/0061343 A1
(43) Pub. Date: Mar. 3, 2022

(54) PROCESS OF TEXTURE IMPROVEMENT FOR CANNED SMALL PELAGIC FISH

(71) Applicant: INSTITUTO TECNOLÓGICO DE LA PRODUCCIÓN, Lima (PE)

(72) Inventors: Josué Cirilo CCOPA RODAS, Lima (PE); Jhason Martín ALAMA ENCARNACIÓN, Lima (PE)

(21) Appl. No.: 17/440,655

(22) PCT Filed: Jul. 16, 2020
(86) PCT No.: PCT/PE2020/050011

§ 371 Date: Sep. 17, 2021

(30) Foreign Application Priority Data
Jun. 24, 2020 (PE) PE000854-2020/DIN

(51) Int. Cl. A23B 4/20; A23L 17/00; A23B 4/03; A23B 4/005

(52) U.S. Cl. CPC A23B 4/20; A23L 17/00; A23V 2002/00; A23B 4/0053; A23B 4/03

(57) ABSTRACT

The present invention refers to a process for improving the sensory quality of pelagic fish with a size between 12 and 16 cm; wherein the conditions in the indirect cooking stages at a temperature of 90 to 95° C. for 20 to 40 minutes and light drying at a temperature of 30 to 40° C. for 13 to 20 minutes, carried out prior to packaging, allows improving the skin texture of the fish in a very important way for the packaging operation and for the end customer

### TECHNICAL FIELD

The present invention refers to a process for improving the sensory quality of small fish such as canned anchovy (Engraulis ringens), from indirect cooking and light drying prior to packaging, in order to satisfy the market needs. This process is included in the food industry sector.

### BACKGROUND OF THE INVENTION

Texture is a very important property of fish muscle, whether raw or cooked (FAO, 1998). Fish muscle can become hard due to frozen storage or soft due to the cooking process. For many years, the canning industry has had problems in the final presentation in rigid or flexible containers of products based on cooked small fish (such as anchovy). Since these have a very flaccid texture, they flake to the consumer's touch, generating rejection in perception of quality by the final consumer, leading to the migration of consumption of other types of hydrobiological products, or failing that, another type of natural resource (animal or plant).

This is due to the fact that the canning industry mostly uses for its processes, cooked fish for filling its containers, previously cooked through a thermal process. This cooking process causes the fish to lose texture, generating a soft product, which is less sensorily palatable than the original.

There are some partial solutions in the state of the art, such as the antecedent U.S. Pat. No. 3,137,581A which shows a process of cooking canned sardines in a heat exchanger, preferably at 93.3° C., and subsequent drying at a temperature of 43° C. Brine is used having a salinity in the range of approximately 20 to 25%, among other stages. However, in this antecedent, brine is used in contact with the fish to carry out the cooking process; when this brine is boiled, the skin of the fish gets weakened, contributing to its physical damage. In that contact is when the oil is removed from the fish, since the purpose of the antecedent is that by cooking the oil itself is removed from the fish and the brine gives the fish the taste of salt. This antecedent requires draining at a temperature of 62° C.-65° C. in 1 hour-time, in order to remove the brine with oil released from the fish; likewise, drying is carried out for 1 hour, which causes a delay in the production process. Another disadvantage of this antecedent is that the high temperatures it uses would not allow the fish to be packaged in flexible containers (retortable pouches) or glass containers.

Another antecedent is the patent document ES2311365B2 (“Procedure to restore and/or improve the nutritional and/or sensory quality of canned fish”) shows that, in the cooking process, the fish loses its own juices, dragging proteins and other elements especially nutrients, such as salts and trace elements, this loss causes a change in texture. For this reason, it recovers these juices or broths from fish cooking and are reincorporated into the fish muscle through a fish paste, gruel or pulp. Likewise, patent document EP1601252B1 (“Preparation method to preserve fish-based food products”) shows that, to preserve cooked fish-based products, it is necessary to perform steps such as: filleting, washing, cutting, curing through a marinade mixture containing dry salt, pepper, sugar, vaporized alcohol and vaporized aromatic oil; these ingredients are marinated with the fish, then rinsed and dried for approximately 36 hours and finally packed.

In this sense, part of the technical difficulty refers to the direct cooking process, where the fish is cooked with steam or water in direct contact, this generates a substantial loss of skin texture. It is surprising that, due to what is known as a problem in the canning industry, no extensive information has been found on the problem, until now.

To solve this problem, the patent CN109770272A (“Production method of integral instant fish meat”) has been developed, which comprises the following steps: selecting fish; removing external and internal impurities from the fish; marinating in vinegar; drying and drainage; drying and cooling; cooking and vacuum packing. However, patent CN109770272A presents a non-continuous, highly expensive and complex procedure, in addition to the fact that the conditions are not suitable for small pelagic species between 12 and 16 cm in size.

### DESCRIPTION OF THE INVENTION

Taking into consideration the problems set out above, the solution in the present invention aims to provide a continuous process for improving the texture of canned pelagic fish of a size between 12 and 16 cm; this process improves sensory quality, as the skin obtained is more consistent than those produced with current state-of-the-art processes.

In this sense, the procedure developed comprises an indirect cooking followed by light drying at a temperature between 30-40° C. for 13 to 20 minutes; with these variations in the cooking process presented in the state of the art, it is possible to improve the texture of the skin of the fish, satisfying the needs of certain markets, due to the fact that it has a better physical appearance both to touch and sight, according to the organoleptic analysis carried out.

The procedure comprises the following stages:
(a) Conditioning the fish or raw material, at this stage the head and tail are cut off, and the viscera are removed, done manually or mechanically under adequate hygienic conditions; this stage is intended to increase its preservation; also, taking them to refrigeration and then continue with the process;
(b) Cleaning the fish with drinking water cooled with ice at a temperature between 0° C. and 4° C., in order to remove foreign matter, keeping the temperature of the product under control;
(c) liquid phase, in this stage the fish are immersed in brine at 6% to 8% for a 5 minutes to 8 minutes; it is carried out immediately after cleaning, the purpose of brining is: i) to eliminate the blood (remains of blood and viscera), ii) to improve the texture and iii) to give the fish meat a slight flavor;
(d) carrying out indirect cooking and light drying; it is preferably carried out in an indirect cooker, at a temperature from 90° C. to 95° C., for 20 to 40 minutes, in which the fish are not in direct contact with the steam or water applied for cooking, this being a continuous process, a light surface drying is applied at a temperature between 30° C. and 40° C. for an estimated time of 13 to 20 minutes; the latter is carried out in order to handle the subsequent operation, as these fish can be used in flexible containers (retortable pouches), being easy to handle by food operators;
(e) packaging the product from the previous stage, in this stage it is placed in the chosen container, which can be a flexible or rigid container;
(f) adding a protective liquid to the product of the previous stage in order to impart taste in the preserves, oil is added between 5 and 15 ml;
(g) sealing the preserves, so that the product developed is not in direct contact with the environment, proceed to seal; and
(h) sterilizing the preserves, in order to destroy or inactivate any microorganism that could proliferate at product storage temperatures; with this stage the product is commercially sterile and can be stored at room temperature.

The technical effect of the present invention is that the process used for cooking with an indirect cooker at a temperature between 90° C. and 95° C. and a specific time for 20 to 40 minutes make it possible to avoid the contact of steam and/or water with the fish, which helps to prevent the skin of the fish from being damaged; the stage of draining at a hot temperature for a certain time is discarded, since the indirect cooker is in charge of draining the “sweat” from the fish. The drying used in the present invention at a relatively low temperature of 30° C. to 40° C. for a short time of 13 to 20 minutes (light drying) allows adequate handling by the operator who has to handle the fish and place them in the containers. The flexible or rigid containers and the low temperatures used prevent the preserves from being affected by the pressure of the vacuum in the container. It is possible to reduce the drying time and temperature compared to other processes of the state of the art; this may be because it is not necessary to dry the product with the container.

### BRIEF DESCRIPTION OF THE FIGURE

The FIGURE to be submitted is described below.

FIG. 1: It shows the depicted scheme of the canning process, the characteristic stage being indirect cooking at a temperature of 90° C. to 95° C. for 20 to 40 minutes and light drying at a temperature of 30° C. to 40° C. for 13 to 20 minutes.

### PREFERRED EMBODIMENT OF THE INVENTION

As mentioned above, the present invention refers to a process for improving the texture of pelagic fish with a size between 12 and 16 cm, since it is in these smaller species that the canning sector has problems for the operation of container filling, and problems with the final consumer who assumes that the soft texture is due to quality problems at the beginning of the process.

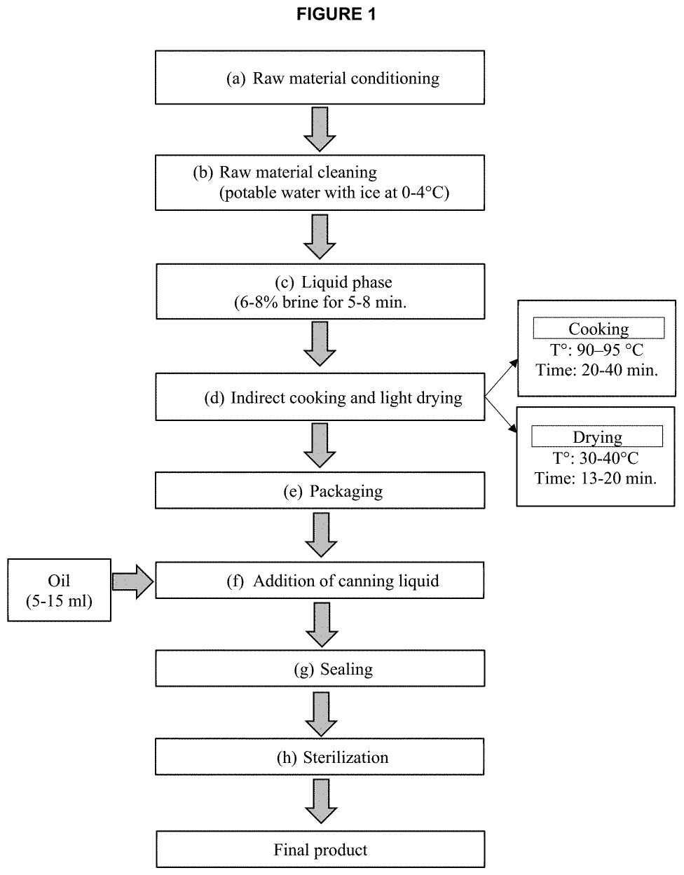

As the schematic form is described in FIG. 1, the process of the present invention starts with the conditioning of the raw material, in which the head and tail are cut off and the viscera of the fish are removed, then they are carefully cleaned with cold drinking water, once clean they are brined at a concentration of 6% to 8% for 5 to 8 minutes, cooking is carried out for a period of 20 to 40 minutes at a temperature of 90° C. to 95° C., followed by light drying in the same continuous stage for a period of 13 to 20 minutes at a temperature of 30° C. to 40° C. These specimens, cooked and dried, are taken to the chosen container, that can be a flexible or rigid container, in which the specimens are covered with a protective liquid, to be sealed.

These sealed preserves are sterilized to ensure the safety of the product, through commercial sterility, after this process the product has a useful life of approximately 2 to 4 years in the environment, depending on the type of container to be used. In short, this product does not need refrigeration.

1. A process to improve the texture of the skin of pelagic fish with a size between 12 and 16 cm, characterized in that it comprises the following stages:
(a) conditioning the fish, cutting off the head and tail and removing the viscera from the fish;
(b) cleaning the fish with drinking water at a temperature between 0° C. and 4° C.;
(c) immersing the fish in brine at 6% to 8% by weight for a time of 5 to 8 minutes, this is known as the liquid phase;
(d) cooking for a period of 20 to 40 minutes at a temperature of 90 to 95° C., then carry out a light drying in the same continuous stage for a period of 13 to 20 minutes at a temperature of 30° C. to 40° C.;
(e) packaging the product obtained at stage d;
(f) adding a protective liquid to the product of stage e;
(g) sealing the product obtained at stage f;
(h) sterilizing the product obtained at stage g.

2. The process to improve the texture of the skin of small-sized canned fish according to claim 1, characterized in that the protective liquid of stage (f) is oil.

3. The process to improve the texture of the skin of small-sized canned fish according to claim 1, characterized in that step (e) is carried out in flexible or rigid containers.
